(19) United States
(12) Patent Application Publication
(10) Pub. No.: US 2003/0126276 A1
(43) Pub. Date: Jul. 3, 2003

(54) Automated content integrity validation for streaming data

(76) Inventors: Gregory C. Kime, Portland, OR (US); Rama R. Menon, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/038,023

(22) Filed: Jan. 2, 2002

(51) Int. Cl. G06F 15/16; G06F 15/173

(52) U.S. Cl. 709/231; 709/224

(57) ABSTRACT

A client requests a data stream from a server. The server samples the data stream. The server generates one or more fingerprint blocks for one or more sampled portions of the data stream. The server sends the data stream to the client. The client receives the data stream. The client samples the data stream. The client generates one or more fingerprint blocks for one or more sampled portions of the data stream. The client compares one or more fingerprint blocks generated at the client to one or more fingerprint blocks generated at the server.

### FIELD OF THE INVENTION

The present invention relates to the field of electronic content distribution. More particularly, the present invention relates to the field of streaming media content distribution.

### BACKGROUND OF THE INVENTION

Streaming is a technique for transferring data such that it can be processed as a steady and continuous stream. Many real-time events, such as live news items, have to be streaming events or else they may become much less relevant and less valuable. Also, streaming allows a personal computer (PC) user connected to the Internet to play a multimedia file, such as an audio or video file, in real time without having to wait for the entire file to be downloaded. This is important because many users do not have sufficiently fast access to the Internet to download a large multimedia file in an adequately short amount of time. Typically, data streams are generated and distributed by streaming content providers (SCPs).

An SCP may map a data stream to a Uniform Resource Locator (URL) to provide users access to the data stream through readily available player programs which are commonly integrated with Internet browser programs. To begin a viewing or listening session, a user may direct a player program or browser program to the URL of a desired data stream. However, a user may encounter unexpected interruptions during playback caused by drop-outs in delivery. Drop-outs may be caused by network delivery problems introduced through various elements in distribution logic used to deliver the data stream from its source to the end user.

An SCP may provide streaming content generation and delivery services to resellers of streaming content, such as Internet radio stations and Internet service providers (ISPs), who provide end users access to the streaming content. It is common for a service level agreement (SLA) between an SCP and a reseller to include a provision that commits the SCP to a specified level of content delivery accuracy, as well as penalty provisions if the specified level of accuracy is not achieved.

In today's Internet content delivery systems, there are no mechanisms to ensure that integrity of streaming content is preserved from its source to its destination, for example, an end user. Therefore, in an attempt to assure accuracy, an SCP may employ human operators to direct a player program to the URL of a data stream in order to validate that the content is streamed correctly. To employ human operators for content integrity validation (CIV) is expensive and directly impacts scalability of operations due to the limited number of data streams a human operator can validate. Further, because the process involves human interaction, the possibility of human error exists.

### BRIEF DESCRIPTION OF THE DRAWINGS

The present invention is illustrated by way of example and not limitation in the figures of the accompanying drawings, in which like references indicate similar elements, and in which:

FIG. 1 shows a global view of an exemplary streaming content delivery network (SCDN) capable of performing automated content integrity validation (CIV) according to the present invention.

FIG. 2 shows a client-server view of a SCDN according to one embodiment of the present invention.

FIG. 3 shows another client-server view of a SCDN according to one embodiment of the present invention.

FIG. 4 shows a flow diagram illustrating, for one embodiment, the operation of CIV according to the present invention.

FIG. 5 shows an exemplary data packet containing a fingerprint block and sampling parameters.

FIG. 6 shows a flow diagram illustrating, for one embodiment, the operation of CIV to accommodate a level of loss in streaming content delivery.

### DETAILED DESCRIPTION

The following detailed description sets forth an embodiment or embodiments in accordance with the present invention. In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

### An Exemplary Streaming Content Delivery Network

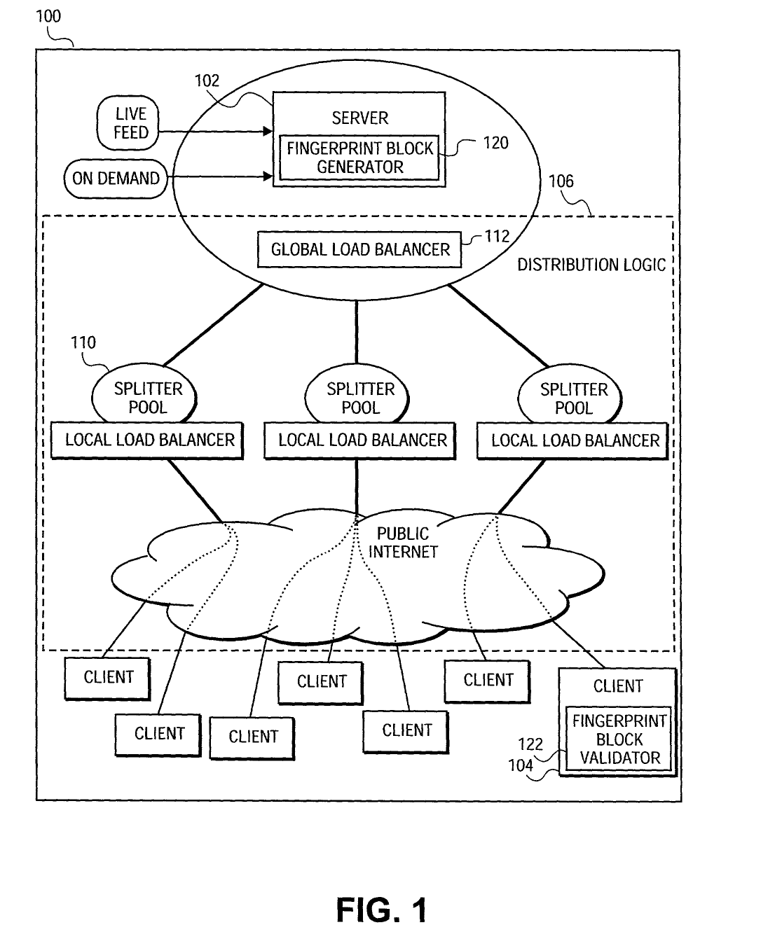

FIG. 1 illustrates a global view of an exemplary streaming content delivery network (SCDN) 100 of a streaming content provider (SCP) capable of performing automated content integrity validation (CIV), according to one embodiment of the present invention. As illustrated, an SCDN may comprise a server 102, clients, such as client 104 and distribution logic 106. The server may comprise any suitable computer system and equipment to generate and deliver streaming media content to other computer systems, such as the client, through the distribution logic. The client may comprise any suitable computer system to receive streaming media content from the server through the distribution logic. For one embodiment, the client may be a personal computer (PC) of an end user connected to the Internet.

The distribution logic may comprise a public network such as the Internet, a private network such as a corporate network, or any combination of suitable public and private networks. The distribution logic may also comprise last mile technologies used by an end user to connect to the Internet, such as a modem or digital subscriber line (DSL). As illustrated, for one embodiment, distribution logic may comprise a global load balancer 112, splitter pools with local load balancers, such as splitter pool 110, and the public Internet. Global load balancers, local load balancers, splitters, and other elements in the distribution logic create additional switching points between the server and client that may introduce network delivery problems resulting in lost packets. Problems with last mile technologies used by a client to connect to the Internet, such as poor quality telephone lines, may also result in lost packets.

To detect lost packets, an SCP may perform automated CIV. For one embodiment, the server may sample a data stream with a fingerprint block generator (FBG) 120 to generate one or more fingerprint blocks for the data stream. The server may send the one or more fingerprint blocks generated at the server to a client requesting the data stream. The client, downstream of the distribution logic, may sample the data stream with a fingerprint block validator (FBV) 122 to generate one or more fingerprint blocks for the data stream at the client. The client may compare one or more fingerprint blocks generated at the client to one or more fingerprint blocks generated at the server. Missing or mismatched fingerprint blocks may indicate lost packets due to possible network delivery problems.

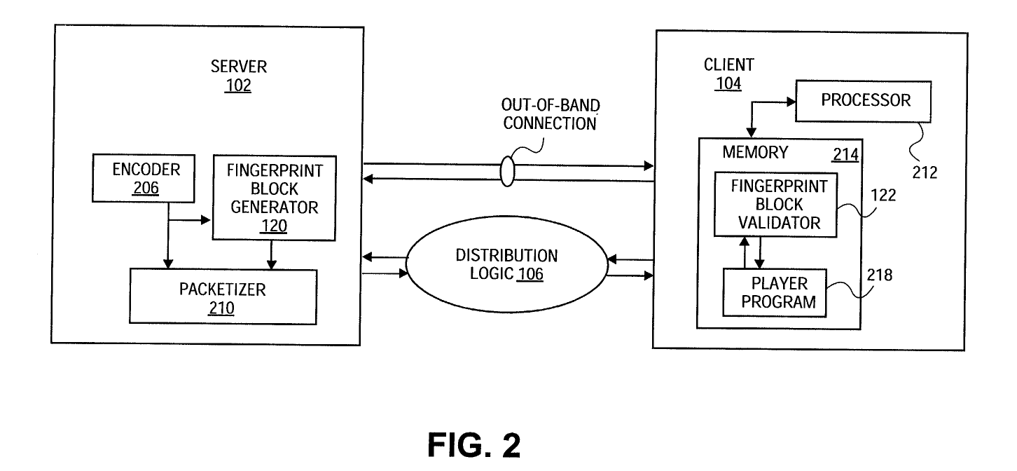

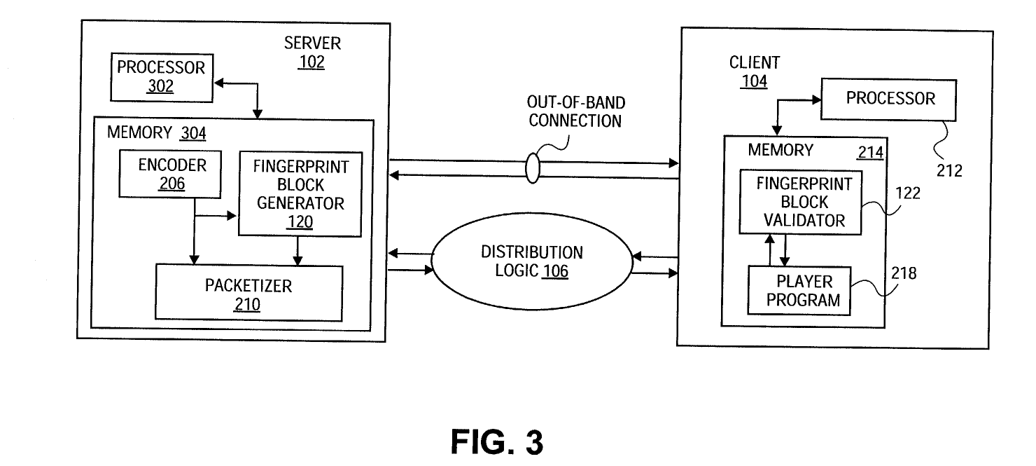

FIG. 2 illustrates a client-server view of SCDN 100 that provides further detail of server 102 and client 104, according to one embodiment of the present invention. As illustrated, the server may comprise an encoder 206, a fingerprint block generator (FBG) 120, and a packetizer 210. The encoder, the FBG 120, and the packetizer 210 may be implemented in software or hardware. For example, as illustrated in FIG. 3, the server may comprise a processor 302 and a memory 304, to store data and instructions for execution by processor 302 to implement the encoder 206, the FBG 120, and the packetizer 210.

The encoder may encode a media signal to create a data stream of an appropriate format. For one embodiment, encoding may comprise sampling the media signal and compressing the resulting information so that it can efficiently be sent over the Internet. As an example, because many users connect to the Internet using 28.8 kilobits per second (kbps) modems, the server may comprise an encoder that compresses an audio signal into a 20 kbps audio data stream.

The FBG may sample the data stream created by the encoder to generate a fingerprint block for the sampled portion of the data stream. The FBG may generate a fingerprint block according to any suitable method, for example, that may generate a different fingerprint block if a single bit of data in the sampled portion is changed. For one embodiment, the FBG may generate a fingerprint block by sampling the data stream and generating a cyclic redundancy check (CRC) on a sampled portion. CRC algorithms are well known in the art, and any suitable form of CRC algorithm may be used to generate fingerprint blocks for a data stream. For example, fingerprint blocks maybe 16-bit (CRC-16) or 32-bit (CRC-32) values, generated using any suitable CRC polynomial. CRC algorithms may be implemented in hardware or software. For one embodiment, the FBG may sample portions of a data stream for predetermined periodic intervals and generate fingerprint blocks for the sampled portions. As an example, the FBG may periodically sample a predetermined length of the data stream that is equivalent to a predetermined amount of playback time.

As illustrated in FIGS. 2 and 3, encoded data created by the encoder may be fed to the packetizer. For one embodiment, the packetizer may create packets of streaming data by appropriately fragmenting a continuous encoded bit stream from the encoder such that the data packet size fits within network imposed limits. The packetizer may also place fingerprint blocks for a data stream generated by the FBG in data packets to be sent to a client requesting the data stream.

It may be important for a client requesting the data stream to have the ability to sample the data stream in the same manner as the server in order to generate fingerprint blocks for the same sampled portion. Therefore, for one embodiment, the FBG may output fingerprint blocks to the packetizer, along with sampling parameters used to generate the fingerprint blocks. The packetizer may place the sampling parameters, along with the fingerprint blocks in data packets to be sent to a client requesting the data stream. The client requesting the data stream may use the sampling parameters to sample the data stream in the same manner as the server, and may generate a fingerprint block for the same sampled portion as the server.

As illustrated in FIGS. 2 and 3, a client may comprise a processor 212 and a memory 214, to store data and instructions for execution by processor 212. For one embodiment, a memory may have stored therein a set of instructions to implement a fingerprint block validator (FBV) 122 and a player program 218.

The player program may be a proprietary or readily available player program capable of playing streaming content. Examples of readily available player programs include Windows Media™ Player available from Microsoft Corporation and RealPlayer® available from RealNetworks, Inc. The player program may be integrated into an Internet browser program as a plug-in application that is loaded when the browser program detects an incoming data stream of an appropriate format. Examples of the Internet browser program include Internet Explorer available from Microsoft Corporation and Netscape Navigator® available from Netscape Communications Corporation.

The FBV may be a plug-in module integrated with the player program. The FBV may sample the data stream and generate fingerprint blocks for the sampled portion. For one embodiment, the FBV may receive fingerprint blocks generated at the server. As previously described, the FBV may also receive sampling parameters from the server. For one embodiment, the FBV compares fingerprint blocks generated at the client to fingerprint blocks generated at the server.

As illustrated, while the server and the client may comprise memory, they may comprise any machine-readable medium, including any mechanism that provides information in a form readable by a machine, such as a computer. For example, a machine-readable medium may include read only memory (ROM), random access memory (RAM), magnetic disk storage media, optical storage media, flash memory devices, and electrical, optical, acoustical, or other forms of propagated signals.

### Automated Content Integrity Validation

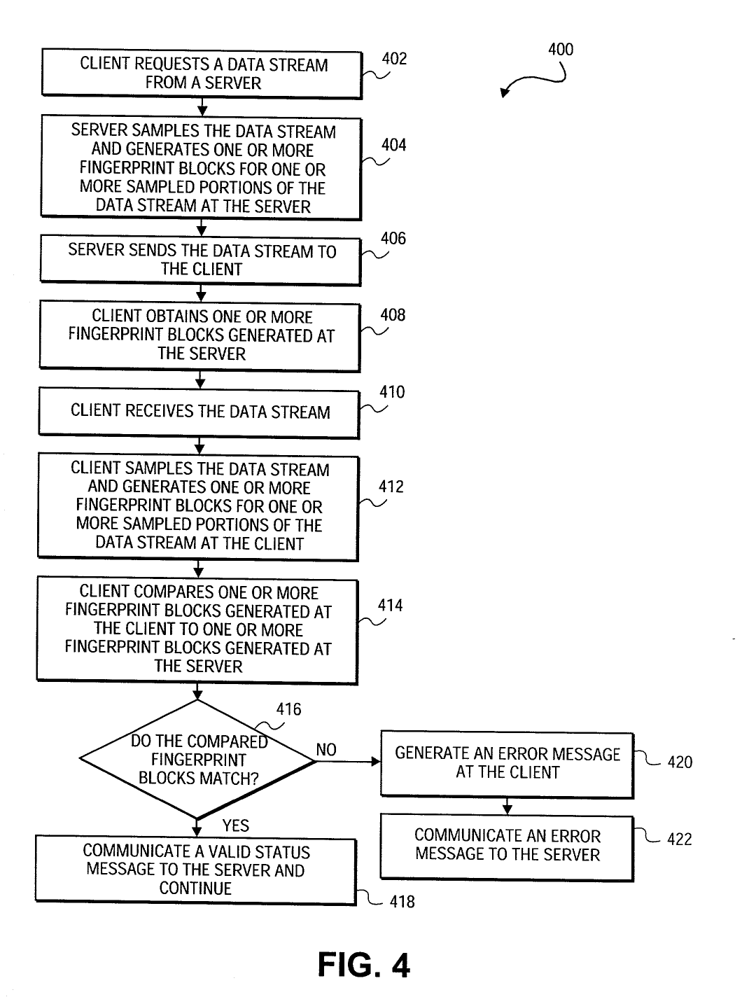

Flow diagram 400, of FIG. 4, illustrates the operation of automated content integrity validation (CIV) according to one embodiment of the present invention. For block 402, the client requests a data stream from the server. For example, the request may result from an end user directing a player program to a URL of the data stream. For block 404, the server samples the data stream and generates one or more fingerprint blocks for one or more sampled portions of the data stream at the server. For block 406, the server sends the data stream to the client.

For block 408, the client obtains one or more fingerprint blocks generated at the server. For one embodiment, one or more fingerprint blocks generated at the server are sent to the client through the distribution logic, in response to the request for the data stream. For one embodiment, the server may send one or more fingerprint blocks to the client through a first connection between the server and the client while sending the data stream to the client through a second connection between the server and the client. For example, the server may send the data stream to the client through a primary data connection while sending fingerprint blocks to the client through an out-of-band connection.

For one embodiment, the client may obtain one or more fingerprint blocks prior to requesting the data stream. This may be possible if the requested data stream is delivered on-demand, such as a data stream for a pre-recorded song. Because the content of a data stream delivered on-demand may be predetermined, fingerprint blocks may be generated prior to receiving a request for the data stream.

For one embodiment, the client may receive a formatted electronic mail (e-mail) message containing fingerprint blocks generated for a data stream delivered on-demand, download the fingerprint blocks from a website, or install them as an automatic update for the player program. Fingerprint blocks obtained prior to requesting a data stream may be stored in a database on the client. It should be noted that fingerprint blocks may not be generated ahead of time for live data streams because the content of a live data stream is not predetermined.

For block 410, the client receives the data stream. For block 412, the client samples the data stream and generates one or more fingerprint blocks for one or more sampled portions of the data stream at the client. For one embodiment, the client may sample the data stream in accordance with sampling parameters obtained from the server. As previously described, the server may send the sampling parameters to the client in data packets containing fingerprint blocks.

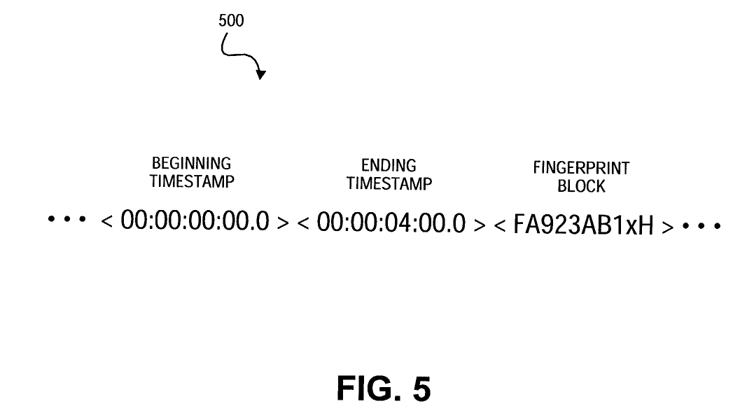

FIG. 5 illustrates, for one embodiment, a portion of an exemplary data packet 500 having a fingerprint block and sampling timestamps defining the portion of the data stream sampled to generate the fingerprint block. As illustrated, the first field may contain a beginning timestamp, the second field may contain an ending timestamp, and the third field may contain a fingerprint block, for example a 32-bit CRC value. As an example, a timestamp may have the following format:

hours:minutes:seconds:frames.subframes

to indicate a precise point in the data stream. Therefore, a client receiving a data stream may sample the data stream from the point indicated by the beginning timestamp to the point indicated by the ending timestamp, and generate a fingerprint block for the sampled portion.

Referring back to FIG. 4, for block 414, the client compares one or more fingerprint blocks generated at the client to one or more fingerprint blocks generated at the server. If the compared fingerprint blocks match, the integrity of the content of the data stream is validated, and the YES branch of block 416 is taken.

For block 418, the client communicates a valid status message to the server and continues processing the data stream. The server may, for example, monitor a connection between the server and the client for a valid status message after sending a data stream from the server to the client. Absence of the valid status message from the client may indicate a network delivery error. For one embodiment, the server may generate an alarm message if a predetermined amount of time passes without receiving a valid status message from the client to notify appropriate personnel of a potential network delivery error. For one embodiment, the server may continue to sample the data stream and generate fingerprint blocks for sampled portions of the data stream while sending the data stream to the client. Therefore, steps 404 through 416 may be repeated while the client receives the data stream.

If one or more fingerprint blocks generated at the client do not match one or more fingerprint blocks generated at the server, content integrity of the data stream is invalidated and the NO branch of block 416 is taken. Mismatched fingerprint blocks may indicate a network delivery error.

Therefore, for block 420, an error message is generated at the client, to indicate that a CIV error has occurred. The error message may allow a user to retry, for example, to request the data stream from the server again, or exit without retrying. For one embodiment, the FBV may generate an error message if a requested data stream is not received in a predetermined maximum time period. For one embodiment, a player program may optionally disable CIV in order to play data streams delivered from servers that do not generate fingerprint blocks for delivered data streams.

For block 422, the client communicates an error message to the server to indicate that a CIV error has occurred. When a CIV error is received by the server, for example, appropriate personnel may be notified of a possible network delivery error. For one embodiment, diagnostic information may be included with the error message, such as the URL of the requested data stream and fingerprint blocks generated, or received for the data stream. Such diagnostic information may assist appropriate personnel in determining the source of the error, for example, the element in the distribution logic that may have caused the loss of content integrity.

According to the method illustrated by flow diagram 400, a single lost packet may cause mismatched fingerprint blocks, which may result in invalidation of content integrity for a data stream. However, for one embodiment, a method of automated content integrity validation may accommodate some number of lost packets in a streaming content delivery system.

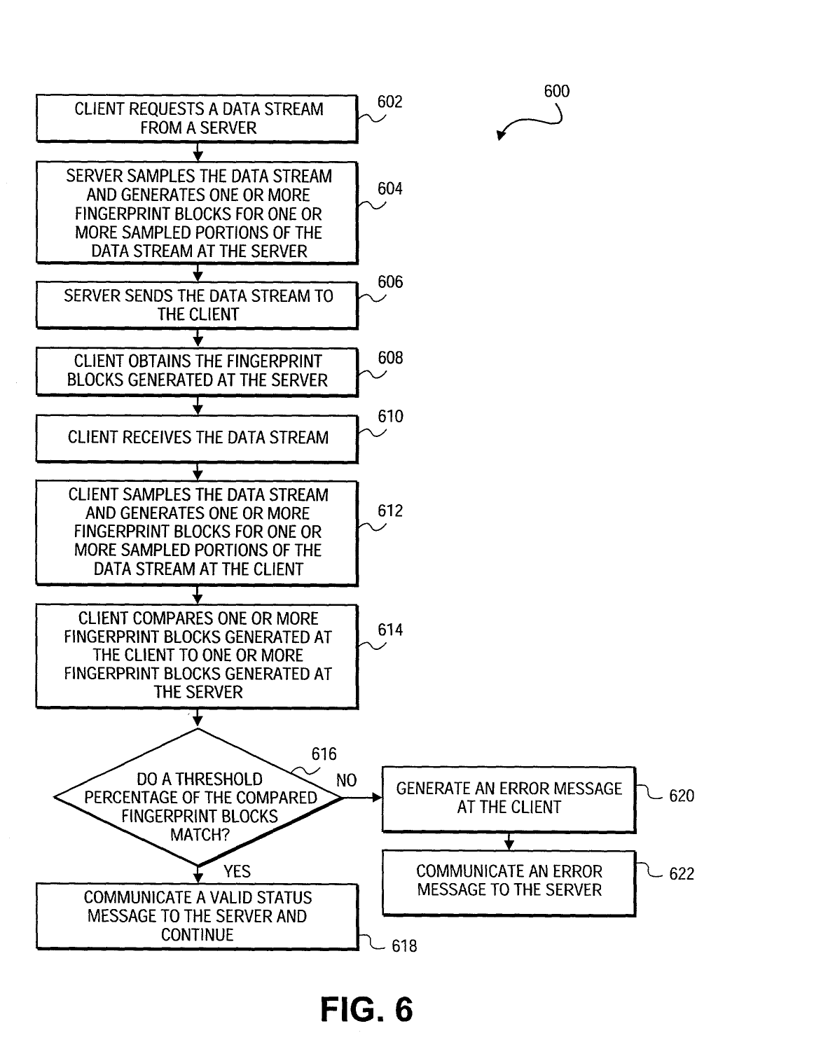

Flow diagram 600, of FIG. 6, illustrates the operation of a method to perform content integrity validation that allows validation of content integrity after a number of mismatched fingerprint blocks. Flow diagram 400 and flow diagram 600 comprise the same operations through block 614, where the client compares one or more fingerprint blocks generated at the client to one or more fingerprint blocks generated at the server. However, for block 616, if a threshold percentage of the compared fingerprint blocks match, the YES path of block 616 is taken. If a threshold percentage of the compared fingerprint blocks do not match, content integrity of the data stream is invalidated and the NO branch of block 616 is taken.

For one embodiment, a percentage of fingerprint block matches may be calculated by dividing a number of fingerprint blocks generated at the client that match fingerprint blocks generated at the server by a total number of fingerprint blocks generated at the client. For example, if each fingerprint block generated at the client matches a fingerprint block generated at the server, the percentage may be one hundred. Therefore, by establishing a threshold percentage below one hundred, the method illustrated in flow diagram 600 may accommodate a number of lost packets that result in mismatched fingerprint blocks. For one embodiment, a threshold percentage may be adjusted to accommodate connections with varying levels of loss. For another embodiment, a threshold number, rather than a threshold percentage, may be established so that if the threshold number of fingerprint blocks generated at the server do not match fingerprint blocks generated at the server, content integrity of the data stream is invalidated.

As previously described, the client may establish a primary data connection with the server to receive the data stream, as well as an out-of-band connection with the server. The out-of-band connection may be used to communicate CIV status messages to the server while the client is receiving the data stream through the primary data connection. The out-of-band connection may enable the server to take appropriate action to correct a CIV error and monitor the out-of-band connection to determine if the error is still present.

For one embodiment, a log file may be created and updated based on CIV results. The log file may be created at the server or the client. For example, the log file may contain data indicative of the number of successful and unsuccessful validations that occurred for a particular data stream, along with associated time stamps. This data may be used to determine a measure of content delivery accuracy. Such a measure may be useful in determining if a level of content delivery accuracy specified in a service level agreement (SLA) between a streaming content provider (SCP) and a reseller has been achieved. For one embodiment, a log file generated at the client may be uploaded periodically by the server.

For one embodiment, specific versions of fingerprint block validators (FBVs) may integrate with existing, readily available player programs, as plug-in modules, to enable the player programs to perform automated CIV. For example, one plug-in module may integrate with Windows Media™ Player player program, while another plug-in module may integrate with RealPlayer® player program.

For one embodiment, an automated CIV system may be developed to provide an SCP with information regarding its delivery network. For example, referring back to FIG. 1, an SCP may establish a plurality of clients downstream of the distribution logic used to deliver streaming content from the server to the clients. The clients may be physically located to access streaming content through different paths in the distribution logic, for example, through different splitter pools. Special player programs may be developed and utilized at the clients, for example, to periodically access streaming content provided by the SCP through a list of URLs, and log the results as previously described. Diagnostic information received at the server from the different clients may provide the SCP with greater assurance that the integrity of streaming content is preserved through different paths in the distribution logic, or may indicate elements in the distribution logic that may have perturbed the integrity of the streaming content.

In the foregoing description, the invention has been described with reference to specific exemplary embodiments thereof It will, however, be evident that various modifications and changes may be made thereto without departing from the broader spirit or scope of the present invention as defined in the appended claims. The specification and drawings are, accordingly, to be regarded in an illustrative rather than a restrictive sense.

What is claimed is:

1. A method comprising:
receiving a request for a data stream from a client;
sampling the data stream;
generating one or more fingerprint blocks for one or more sampled portions of the data stream;
sending one or more fingerprint blocks to the client; and
sending the data stream to the client.

2. The method of claim 1, comprising sending to the client parameters for sampling the data stream.

3. The method of claim 1, wherein generating one or more fingerprint blocks comprises generating cyclic redundancy check (CRC) values for the one or more sampled portions of the data stream.

4. A method comprising:
requesting a data stream by a client from a server;
receiving the data stream by the client;
sampling the data stream at the client;
generating one or more fingerprint blocks for one or more sampled portions of the data stream at the client; and
comparing one or more fingerprint blocks generated at the client to one or more fingerprint blocks generated at the server.

5. The method of claim 4, comprising obtaining by the client one or more fingerprint blocks generated at the server.

6. The method of claim 4, comprising generating an error message at the client if one or more fingerprint blocks generated at the client do not match one or more fingerprint blocks generated at the server.

7. The method of claim 4, comprising communicating an error message to the server from the client if one or more fingerprint blocks generated at the client do not match one or more fingerprint blocks generated at the server.

8. The method of claim 4, comprising communicating a valid status message to the server from the client if one or more fingerprint blocks generated at the client match one or more fingerprint blocks generated at the server.

9. A method comprising:
requesting a data stream from a server by a client;
sampling the data stream at the server;
generating one or more fingerprint blocks for one or more sampled portions of the data stream at the server;
sending the data stream from the server to the client;
receiving the data stream by the client;
sampling the data stream at the client;
generating one or more fingerprint blocks for one or more sampled portions of the data stream at the client; and
comparing one or more fingerprint blocks generated at the client to one or more fingerprint blocks generated at the server.

10. The method of claim 9, comprising sending one or more fingerprint blocks generated at the server to the client.

11. The method of claim 9, comprising communicating an error message to the server from the client if a threshold percentage of one or more fingerprint blocks generated at the client do not match one or more fingerprint blocks generated at the server.

12. The method of claim 10, wherein:
sending one or more fingerprint blocks generated at the server to the client comprises sending one or more fingerprint blocks to the client through a first connection between the server and the client; and
sending the data stream to the client comprises sending the data stream to the client through a second connection between the server and the client.

13. The method of claim 9, wherein generating one or more fingerprint blocks at the server comprises generating cyclic redundancy check (CRC) values for one or more sampled portions of the data stream.

14. The method of claim 9, comprising:
communicating a valid status message from the client to the server if a threshold percentage of one or more fingerprint blocks generated at the client match one or more fingerprint blocks generated at the server; and
generating an error message at the server if the valid status message is not received in a predetermined amount of time.

15. An apparatus comprising:
an encoder to encode a media signal to create a data stream of encoded data;
a fingerprint block generator to sample the data stream and to generate one or more fingerprint blocks for one or more sampled portions of the data stream; and
a packetizer to fragment the data stream to create one or more data packets comprising the encoded data to send to a client.

16. The apparatus of claim 15, wherein the fingerprint block generator comprises circuitry.

17. The apparatus of claim 15, wherein the fingerprint block generator generates one or more fingerprint blocks by generating cyclic redundancy check (CRC) values for one or more sampled portions of the data stream.

18. The apparatus of claim 15, wherein the packetizer creates one or more data packets containing one or more fingerprint blocks generated by the fingerprint block generator.

19. A client comprising:
a processor; and
a memory coupled to said processor having stored therein a set of instructions to cause said processor to request a data stream from a server, to receive the data stream, to sample the data stream, to generate one or more fingerprint blocks for one or more sampled portions of the data stream at the client, and to compare one or more fingerprint blocks generated at the client to one or more fingerprint blocks generated at the server.

20. The client of claim 19, wherein the set of instructions comprises instructions to cause the processor to obtain one or more fingerprint blocks generated at the server.

21. The client of claim 19, wherein the set of instructions comprises instructions to cause the processor to communicate an error message to the server if one or more fingerprint blocks generated at the client do not match one or more fingerprint blocks generated at the server.

22. The client of claim 19, wherein the set of instructions comprises instructions to cause the processor to communicate a valid status message to the server if one or more fingerprint blocks generated at the client match one or more fingerprint blocks generated at the server.

23. A system comprising:
a server comprising a first processor and a first memory coupled to the first processor having stored therein a first set of instructions to cause the first processor to receive a request for a data stream from a client, to sample the data stream, to generate one or more fingerprint blocks for one or more sampled portions of the data stream, to send the one or more fingerprint blocks to the client , and to send the data stream to the client; and
a client comprising a second processor and a second memory coupled to the second processor having stored therein a second set of instructions to cause the second processor to request the data stream from the server, to receive one or more fingerprint blocks generated at the server, to receive the data stream, to sample the data stream, to generate one or more fingerprint blocks at the client for one or more sampled portions of the data stream, and to compare one or more fingerprint blocks generated at the client to one or more fingerprint blocks generated at the server.

24. The system of claim 23, wherein the first set of instructions comprises instructions to cause the first processor to generate the one or more fingerprint blocks by generating cyclic redundancy check (CRC) values for one or more sampled portions of the data stream.

25. The system of claim 23, wherein the second set of instructions comprises instructions to cause the second processor to generate an error message at the client if a threshold percentage of one or more fingerprint blocks generated at the client do not match one or more fingerprint blocks generated at the server.

26. The system of claim 25, wherein the threshold percentage is adjustable.

27. The system of claim 23, wherein the second set of instructions comprises instructions to cause the second processor to generate a log file to store results of comparing one or more fingerprint blocks generated at the client to one or more fingerprint blocks generated at the server.

28. A machine readable medium having stored therein a plurality of machine readable instructions for execution by a processor, the machine readable instructions to:
receive a request for a data stream from a client;
sample the data stream;
generate one or more fingerprint blocks for one or more sampled portions of the data stream;
send one or more fingerprint blocks to the client; and
send the data stream to the client.

29. The machine readable medium of claim 28, wherein the machine readable instructions comprise instructions to generate one or more fingerprint blocks by generating cyclic redundancy check (CRC) values for the one or more sampled portions of the data stream.

30. The machine readable medium of claim 28, wherein the machine readable instructions comprise instructions to send to the client parameters for sampling the data stream.
